(19) United States
(12) Patent Application Publication
(10) Pub. No.: US 2013/0063049 A1
(43) Pub. Date: Mar. 14, 2013

(54) Ballast module for light fixtures

(71) Applicants: Jose Luiz Yamada, Houston, TX (US); Mark E. Lewis, Waller, TX (US); James A. Lewis, Houston, TX (US)

(72) Inventors: Jose Luiz Yamada, Houston, TX (US); Mark E. Lewis, Waller, TX (US); James A. Lewis, Houston, TX (US)

(21) Appl. No.: 13/507,278

(22) Filed: Jun. 18, 2012

Related U.S. Application Data
(63) Continuation-in-part of application No. PCT/US2009/001734, filed on Mar. 19, 2009.
Application No. PCT/US2009/001734 is a continuation-in-part of application No. 12/387,623, filed on May 5, 2009, now Pat. No. 8,201,965.

(51) Int. Cl. F21V 21/00; H05B 37/02

(52) U.S. Cl. 315/313; 362/249.01; 362/382

(57) ABSTRACT

A light fixture having a construction enabling on/off operation with a wall-mounted switch in a circuit by itself or with other fixtures and to be upgraded in “plug and play” fashion to operate independently of other fixtures in the circuit or for stepped dimming. Modular construction provides safety and ease of maintenance in that ballasts are replaced without exposure to internal wiring and provides temperature management by isolating temperature-sensitive components from high temperatures while placing the lamps in an enclosure in which temperature is contained to operate efficiently. If passive thermal management is not enough to maximize operating efficiency and/or service life, the fixture is upgradeable in plug and play fashion to active thermal management. Ballast modules can be equipped with a microcontroller for collecting operational data that is harvested and used to optimize switching to evenly age lamps and electronics or determine energy consumption.

The present application is a continuation-in-part of co-pending International Application No. PCT/US2009/001734, MODULAR, ADAPTIVE CONTROLLER FOR LIGHT FIXTURES, filed Mar. 19, 2009, co-pending U.S. application Ser. No. 12/387,623, MODULAR LIGHT FIXTURES, filed May 5, 2009, and co-pending International Application No. PCT/US2010/002881, CONTROL MODULE FOR LIGHT FIXTURES AND METHOD, the disclosure of each application being hereby incorporated into this application in their entireties by this specific reference.

The present invention relates to modular light fixtures that, by virtue of their construction and because they are constructed of component parts that may be readily and quickly assembled and/or dis-assembled, provide the advantages of safety, accessibility to the electronic and electrical parts of the controller, thermal management, and the ability to be upgraded with components for monitoring and controlling the fixture. Although not limited to this application, the modular light fixtures of the present invention are particularly suited for use with fluorescent fixtures, particularly fluorescents of the type used for so-called high bay lighting.

The need for energy efficiency has driven innovation in the development of lamps for light fixtures and control systems for lighting fixtures. Fluorescent fixtures have been retrofit to many buildings in place of metal halide fixtures to reduce energy consumption. Although fluorescents have been improved by development of so-called T5 or T5HO fluorescent lamps and “quick start” ballasts and ballasts with electronic controls, they have changed only incrementally over the many years that fluorescents have been in widespread use. The fixtures are generally constructed of a metal shroud with a metal bulkhead assembled to the underside of the shroud. Sockets and reflectors (in fixtures utilizing a reflector) are mounted to the bulkhead inside the shroud to direct light from the lamp(s) downwardly and to support and provide electrical connections to the lamp(s), and ballast(s) are mounted on the top side of the bulkhead (under the shroud and on the top surface of the bulkhead) for providing switching and start-up of the lamps in the fixture. In some fixtures, the bulkhead may be hinged to the shroud to facilitate access to the ballast(s) and in other fixtures, the reflector(s) are integral with the shroud.

Although a time-tested design, existing fluorescent fixtures are characterized by a number of disadvantages and limitations. If the ballast of certain types of fluorescent fixtures fails, for instance, the lamps and reflector(s) must be removed and the bulkhead, or socket bracket, dropped out of the shroud (or if the bulkhead is hinged to the shroud; the bulkhead is pivoted downwardly) to access the ballast(s). Removing and replacing the lamps and reflector(s) (in the type of fixture in which the reflectors are not integral with the shroud) is time-consuming and, depending upon the type of fixture, requires that wires inside the fixture be unplugged and re-plugged into appropriate connectors and/or cut and spliced, creating the possibility of improper wiring. Ballasts are available (for instance, the Sylvania QUICKTRONIC PROFESSIONAL SERIES) with terminal strips for push-in connection of the wires, but service personnel are still exposed to bare wires and there is still the possibility of improper connections. Further, when the fixture is opened to access the ballasts and internal wiring, the person(s) servicing the fixture are in close proximity to the electrical parts of the fixture. Even though power to a fixture or circuit is turned off when the fixture is serviced, there is the possibility of an error that could result in contact with a live wire (and some such fixtures operate at 480V), creating a potentially dangerous situation, especially when the fixture is located twenty or more feet above the floor of the building as in the above-mentioned high bay buildings.

Another disadvantage of known fixtures is highlighted by the development of the above-mentioned T5/T5HO lamp. The T5 lamp is smaller than a T8 lamp, making it possible to mount, for instance, six T5 lamps in a fixture roughly the same size as a four lamp T8 fixture, thereby producing more light from a smaller fixture. However, mounting more lamps in a fixture can create temperature problems in the fixture. T5 lamps (like most fluorescent lamps) operate more efficiently at higher temperatures, but the component parts of the ballast, especially electronic ballasts, can be damaged by heat. Ballasts are available that operate at temperatures up to 90° C. (as compared to 60° and 65° C. ballasts that can fail at the temperatures to which they are exposed when used with T5 lamps), but temperature management is a problem, even in fixtures utilizing T8 lamps, in part because of the downward-facing, concave shape of the fixture, which effectively traps heat in the fixture. Ballast manufacturers may warrant their ballast for a certain operating life, but only as long as temperature does not exceed the maximum temp established by manufacturer, and a heat sensitive label or tape is affixed to the outside of the ballast cover to provide a visual indication when/if temperature exceeds maximum allowed, in which case the ballast warranty is invalidated.

Fluorescent fixtures are also available in which the ballasts are mounted under the shroud and/or reflectors and that do not require removal of the lamps and reflector(s) for access to the ballasts. Such fixtures are common in commercial and office buildings, and some residential construction, with suspended ceilings and/or and in which headroom and/or the space between the top of the fixture and the underside of the roof or ceiling may be limited, and also in rooms such as kitchens that require energy efficient, bright area lighting. However, the ballasts of such fixtures are mounted within or under the shroud (or reflector) where the lamps are located such that the ballasts are exposed to the heat of the lamps.

A fixture is known that is provided with what is characterized as a “removable ballast” that is accessible from the bottom of the fixture, but no provisions are made in that fixture for thermal management. Nor is that fixture designed in a way that would be adaptable for controlling the operating temperatures of the ballast or the lamps. The patent literature includes U.S. Pat. No. 6,268,701, which describes a fixture having the ballast mounted within the housing with a fan that is switched on to blow air over the ballast when the light is turned on. However, the fixture described in that patent is itself characterized by certain disadvantages and limitations that affect the utility of that invention. Specifically, as set out above, the lamps of a fluorescent fixture operate more efficiently at higher temperatures, but blowing the air through the fixture over the ballast as described in that patent cools not only the ballast but also the lamps. Note also that if ambient temperature is 30° C. for instance, the fan blows hot air over the ballast of the fixture disclosed in this patent, with the potential for compromising the efficiency and/or durability of the ballast.

Plug-in, so-called “emergency ballasts” are available (see, for instance, Cat. Nos. E-ACLEB0800D, -1400D, and -3000D of the E-conolight (Sturtevant, Wis.) catalog, www.e-conolight.com). However, so far as is known, such ballasts are intended for temporary, limited duty (the “single lamp field installable Plug-N-Go emergency ballast” described in the E-conolight catalog is described in that catalog as being capable of operating “one lamp for 90 minutes”), perhaps because such ballasts leave high voltage wiring exposed in violation of good safety practices. Further, such ballasts may require a dedicated fixture and/or can only be used with fixtures of a certain configuration (the emergency ballast offered in the E-conolight catalog requires that the “fixture must be purchased with ‘E’ option”). Nor can such ballasts be used, so far as is known, in fixtures controlled by remote control or photosensors, or that are part of a centrally-managed, lighting control system.

One fixture, available from The Light Edge, Inc. (Tualatin, Oreg., www.thelightedge.com) addresses this temperature management problem by attaching an enclosed ballast to the aluminum housing of the fixture. However, despite this construction, the design is limited by its upside-down, bowl shape (which traps, or contains, the heat produced by the lamps) and the need to remove the lamps and reflectors to access the ballasts. Ballasts have also been designed with cable connectors to simplify ballast replacement. However, these ballasts are of conventional design and the wiring harness must be enclosed, so the ballast is internal to the fixture or is provided with a secondary enclosure that adds cost and may adversely affect heat dissipation.

It is, therefore, an object of the present invention to provide a lighting fixture that overcomes these disadvantages and limitations that is of modular construction and that is adapted for use with different lamps, including without limitation fluorescents, metal halides, LEDs, and halogen lamps.

Another object of the present invention is to provide a light fixture having a ballast module that is adapted for quick and easy assembly to the light fixture on site and/or to an existing light fixture that is configured so that the ballast module can be releasably mounted to the fixture.

Another object of the present invention is to provide a lighting fixture in which the ballasts and other electronic components are insulated from the heat produced by the lamps and that does not require disassembly of the fixture in the event the ballasts need to be replaced and/or other maintenance needs to be performed on the fixture.

Another object of the present invention is to provide a lighting fixture that is easily and quickly assembled on-site and a ballast module that is easily and quickly assembled to the lighting fixture, or to an existing lighting fixture, on-site.

Another object of the present invention is to provide a lighting fixture that provides easy access to ballasts and other electronic components from above the fixture (so-called “tool-less top access”).

Yet another object of the present invention is to provide a lighting fixture that incorporates a thermal management system for optimizing the life and operating efficiency of the components of the fixture by mounting the electronic components in an enclosure, or compartment, that is separate and insulated from the lamps.

Another object of the present invention is to provide a light fixture incorporating passive and active temperature management for increasing the efficiency of the lamps as well as the service life of the electronic components of the fixture.

Another object of the present invention is to provide improved safety in that the structure of the fixture reduces the need for handling the electrically conductive components of the fixture, for instance, when a ballast must be changed.

Similarly, it is an object of the present invention to provide a lighting fixture in which the time required to change ballasts, or otherwise service the fixture, is reduced.

Similarly, it is an object of the present invention to provide a lighting fixture having a construction that is adapted for releasably mounting a ballast module thereto, the ballast module being easily and quickly detached from the fixture for ease of maintenance.

Another object of the present invention is to provide a lighting fixture optimized for use with the targeted system for switching electrical appliances described in International Application No. PCT/US2008/003845, TARGETED SWITCHING OF ELECTRICAL APPLIANCES AND METHOD, filed Mar. 24, 2008, and/or as part of a wireless or wired control network as described in co-pending application Ser. No. 12/284,394, POINT OF USE AND NETWORK CONTROL OF ELECTRICAL APPLIANCES AND METHOD, both commonly owned, and the disclosures of which are hereby incorporated into this application in their entireties by these specific references.

Yet another object of the present invention is to provide a lighting fixture having a construction that provides all necessary lighting functions in its basic form but that can also be upgraded, without structural changes, to include microprocessor control and/or active thermal management.

Another object of this invention is to provide an apparatus and method whereby the ballast module is equipped with a microcontroller and a real time clock that collects and records operational data. By recording the operational state of the fixture over time, either wirelessly by interrogating the microcontroller or by detaching the ballast module from the fixture and plugging it into a separate computer, the energy usage of each fixture over any time frame can be determined. Collecting operational data by this method is compatible with various systems of control, including step dimming and linear dimming. Similarly, the data collected that is collected is used to determine usage of lamps and electronics to determine remaining useful life and as a guide to make relay sequencing changes to balance the lamp usage, thereby extending the maintenance cycle of the fixture.

Another object of this invention is to provide a device into which the ballast modules can be plugged in for the purpose of testing the device and harvesting the data. If the ballast module is defective or has reached the end of its useful life, the data can be transferred to a replacement ballast module for continuity of historical usage.

This listing of several of the objects of the present invention is intended to be illustrative, and is not intended to be a complete listing of all of the objects of the invention; instead, this listing of several objects of the present invention is intended to be illustrative in the sense that the invention addresses many needs and solves many problems, not all of which are listed here, and that are known in the art. Other objects, and the many advantages of the present invention, will be clear to those skilled in the art from the detailed description of the embodiment(s) of the invention and from the drawings appended hereto. Those skilled in the art will recognize, however, that the embodiment(s) of the present invention described herein are only examples of specific embodiment(s), set out for the purpose of describing the making and using of the present invention, and that the embodiment(s) shown and/or described herein are not the only embodiment(s) of a light fixture constructed in accordance with the teachings of the present invention.

The present invention addresses the above-described needs by providing a light fixture comprising a shroud having sockets mounted therein for supporting and making electrical connection to one or more lamps mounted in the sockets. First and second connectors are mounted to the shroud and electrically connected to the sockets mounted in the shroud and a ballast module is detachably mounted to the shroud on said connectors, the ballast module comprising the electrical circuitry for energizing and operating the lamps, the electrical connections to the electrical connections to the ballast module being made when the ballast module is mounted to the shroud.

Also provided is a modular light fixture comprised of a shroud and a ballast module, the ballast module comprising the electrical circuitry for energizing and operating the lamps of the fixture. The ballast module is mounted to the shroud and makes electrical connections to the lamps supported in the shroud on first and second connectors mounted to the shroud, the first and second connectors being spaced apart from each other by a specified distance whereby the ballast module is mounted to or removed from the shroud in convenient and quick fashion for ease of service.

In another aspect, the present invention provides a modular light fixture comprised of a shroud and a ballast module, the ballast module comprising the electrical circuitry for energizing and operating the lamps of the fixture. Modules are detachably mounted to the ballast module for actively cooling the electrical circuitry within the ballast module and/or for operating the electrical circuitry within the ballast module under control of an external network.

In yet another aspect, the present invention provides a modular light fixture of a construction that manages the heat produced by operation of the lamps in the fixture. Specifically, the heat sensitive electrical circuitry of a ballast module is insulated from the heat produced by operation of the lamps by mounting the ballast module to a shroud in which the lamps are mounted with an air gap between the ballast module and the shroud. In an alternative embodiment, the passive thermal management provided by mounting the ballast module to the shroud with an air gap therebetween is enhanced by active thermal management provided by a fan module mounted to the ballast module for drawing ambient air over the electrical circuitry in the ballast module.

Also provided is a method of managing the heat produced by operating a light fixture comprising the steps of containing the heat produced by the lamps of the fixture within a shroud and isolating the heat-sensitive electrical components for energizing the lamps in the fixture from the heat produced by the lamps of the fixture by mounting a module containing the heat-sensitive electrical components to the shroud with an air gap between the shroud and the module.

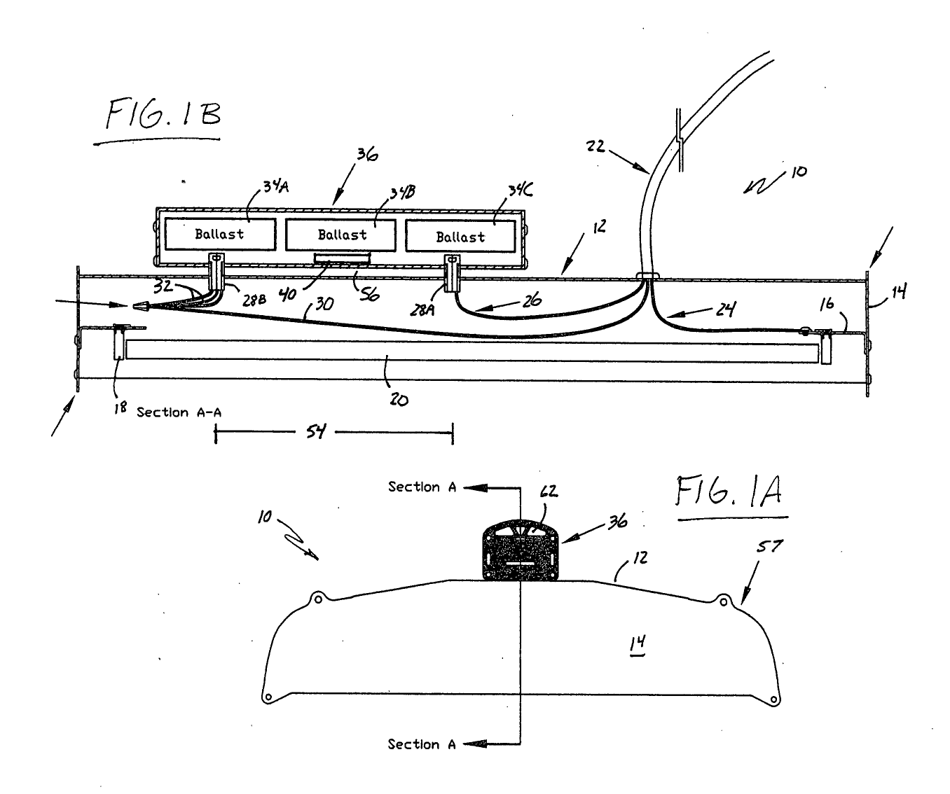

Referring now to the figures, FIGS. 1A and 1B show end and longitudinal sectional (taken along the line A-A in FIG. 1B) views, respectively, of a first embodiment of a modular light fixture constructed in accordance with the teachings of the present invention, the ballast wiring not being shown in FIG. 1A for purposes of clarity.

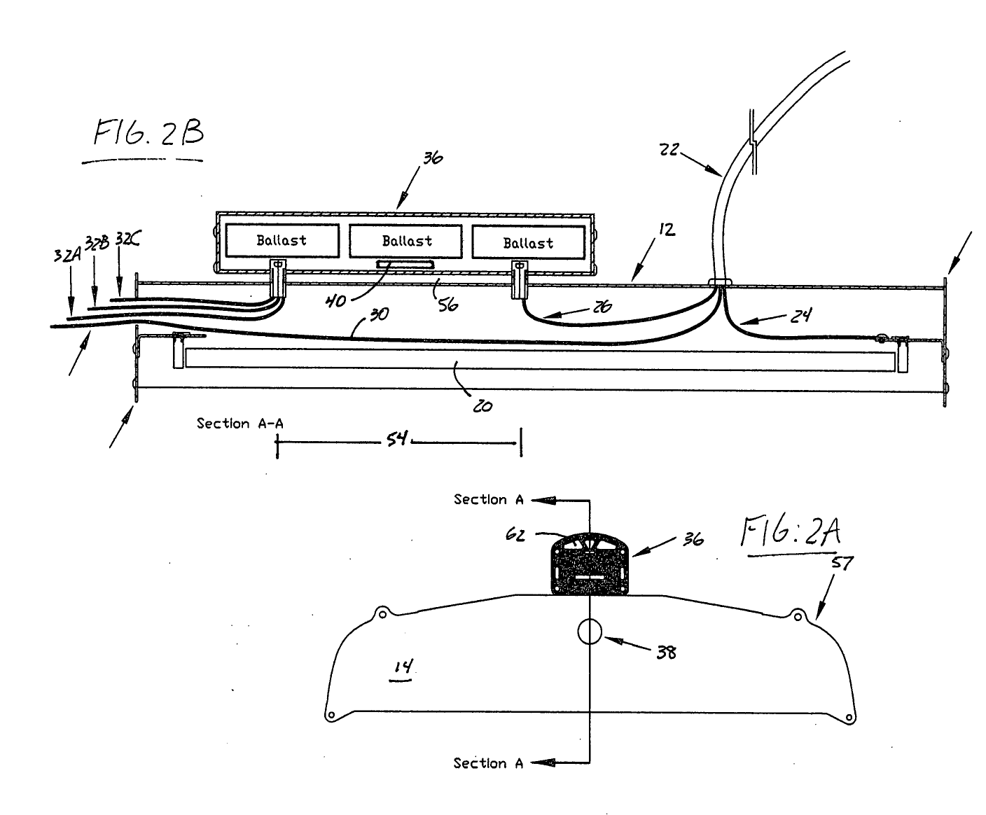

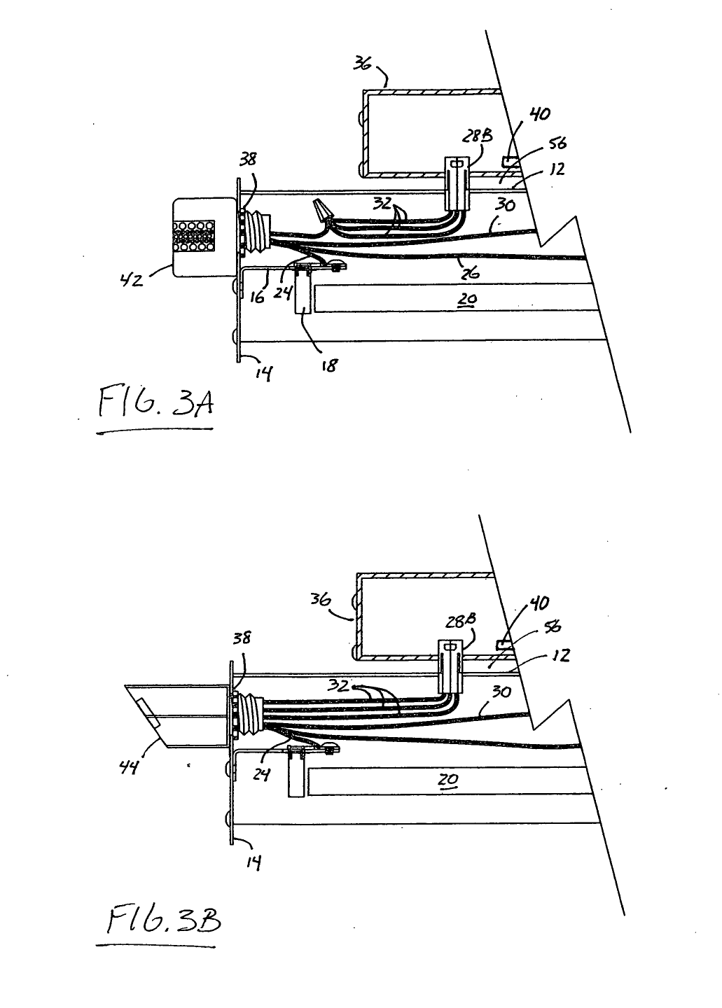

FIGS. 2A and 2B show the same modular light fixture shown in FIG. 1A, but in which the wiring is configured for mounting a controller to the fixture.

FIGS. 3A and 3B show detailed sectional views of a portion of the light fixture of FIG. 2 having different types of controllers mounted thereto.

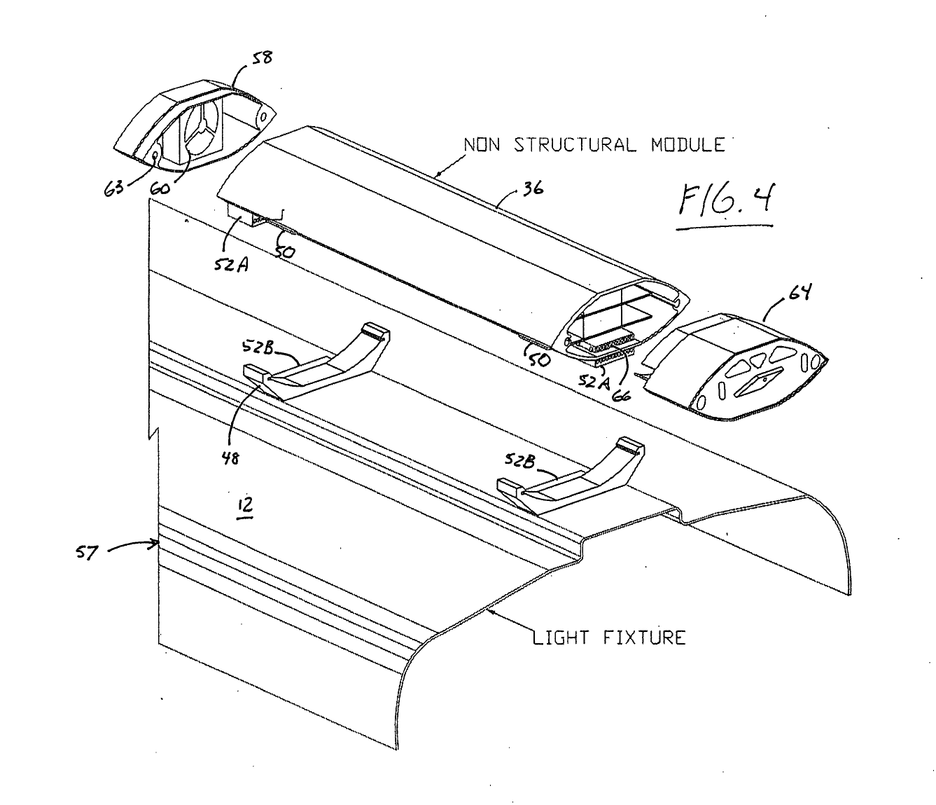

FIG. 4 is a perspective view of a second embodiment of a modular light fixture constructed in accordance with the teachings of the present invention.

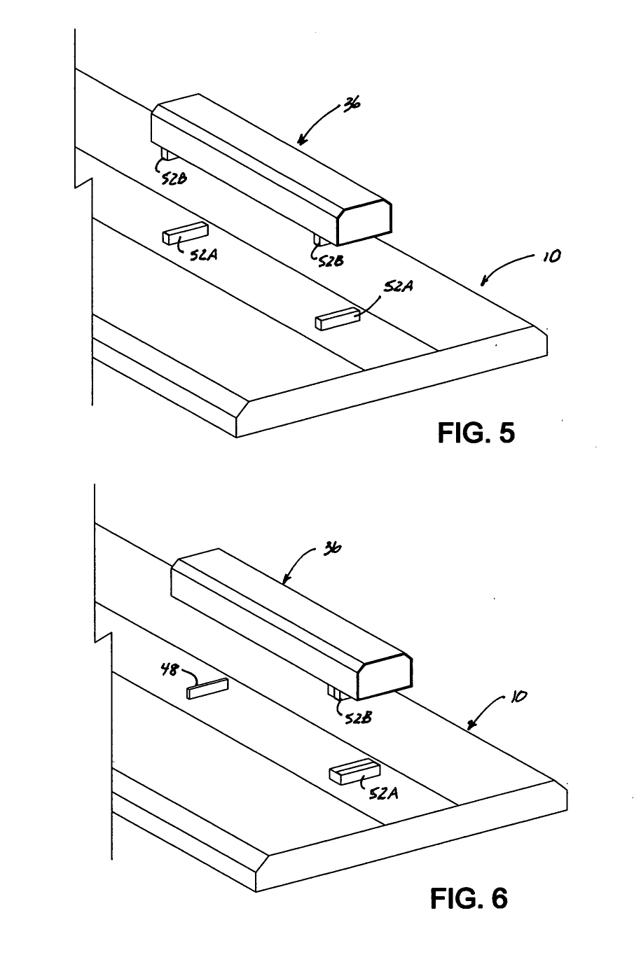

FIG. 5 is a schematic, partially exploded, perspective view of a first embodiment of a ballast module constructed in accordance with the teachings of the present invention for mounting to a conventional fluorescent lighting fixture.

FIG. 6 is a schematic, partially exploded, perspective view of a second embodiment of a ballast module constructed in accordance with the teachings of the present invention for mounting to a conventional fluorescent lighting fixture.

In more detail and with reference to the figures, a first embodiment of the modular light fixture of the present invention is indicated at reference numeral 10. Fixture 10 is comprised of shroud 12 and end plate 14, with socket brackets 16 mounted to the end plates 14 for receiving sockets 18 for supporting and making the electrical connection to a lamp 20 in the manner known in the art. The fixture 10 receives electrical power through conduit 22 comprised of three wires, all as known in the art, the ground 24 and neutral 26 wires being wired to the socket 18 and to a connector 28B described below and the third (supply) wire 30 being wired to connector 28A.

As shown in FIG. 1B, supply wire 30 is tied to three ballast wires 32A, 32B, 32C, corresponding to the three ballasts 34A, 34B, and 34C mounted in ballast module 36, the fixture shown in FIG. 1B being wired for all three ballasts 34 to simultaneously energize a corresponding lamp (or in the more usual configuration, a corresponding pair of lamps in a six-lamp fixture). Referring to FIG. 2B, it can be seen that the supply wire 30 and three ballast wires 32 are pulled through a hole 38, which can be formed as a knock-out in end plate 14 or pre-formed in the end plate and closed off by a grommet or other plug, for wiring as described below for separate switching of the ballasts 34. Referring to FIGS. 3A and 3B, two different controllers for interacting with the microcontroller 40 for the modular fixture 10 are shown (the wiring connections to the microcontroller 40 and ballasts 36 are not shown for purposes of clarity), the first being a photocell 42 (FIG. 3A) for switching all lamps 20 in fixture 10 on and off and the second being a controller 44 (FIG. 3B) of the type described in the above-incorporated application Ser. No. 12/284,394, POINT OF USE AND NETWORK CONTROL OF ELECTRICAL APPLIANCES AND METHOD, and as described in the above-incorporated International Application No. PCT/US2010/002881, CONTROL MODULE FOR LIGHT FIXTURES AND METHOD, for switching individual lamps 20 (or pairs of lamps 20) on and off as light output is stepped up and/or dimmed in accordance with the methods described in that co-pending International Application as each ballast 34A, 34B, 34C is energized.

Connectors 28A, 28B are shown as linear connectors in FIGS. 1, 2, 3, 5, and 6, and a second embodiment of the connectors is shown in FIG. 4. Referring to FIG. 4, means is provided for affixing the ballast module 36 to shroud 12 in the form of a mount, indicated at reference numeral 46, comprised of a stand-off 48 mounted to shroud 12 and guides 50 formed integrally with or mounted to ballast module 36. Male and female electrical connector halves 52A, 52B are mounted to shroud 12 and ballast module 36 is mounted to shroud 12 on mount 46 by engaging the guides 50 to stand-off 48 and then sliding ballast module 36 relative to shroud 12 until the two halves 52A, 52B of electrical connector 28A, 28B are firmly seated in one another. A spring-loaded lock pin 54 is provided at the end of ballast module 36 opposite the direction in which ballast module 36 slides into position on mount 46 that pops up when the two halves 52A, 52B of electrical connectors 28A, 28B are firmly seated so as to provide an affirmative latch and to signal the mating of the connector halves 52A, 52B. As set out above, when seated in this manner, the connectors 28A, 28B operably connect the ballasts (not shown in FIG. 4) in ballast module 36 into the electrical circuit into which fixture 10 is wired.

Those skilled in the art will recognize that the right angle connectors 28A, 28B shown in FIG. 4 can also provide the advantages of the modular fixture 10 of the present invention when formed as linear connectors as shown in the other figures. FIGS. 5 and 6 show how linear connectors 28 (rather than connectors formed in a right angle as shown in FIG. 4) are utilized to mount the ballast module 36 to conventional fluorescent lighting fixtures. Those skilled in the art will recognize that the linear connectors shown may incorporate a positive lock, for instance, in the form of spring loaded prong (not shown) that lands in a detent of the type known in the art, for insuring a secure connection between connector halves. Further, although it may not be as sturdy (depending upon the construction of the connectors) and may not offer the advantage of confirmation of a positive lock between the halves 52A, 52B of the right-angle connectors 28A, 28B shown in FIG. 4, those skilled in the art will recognize that the single connector 28 may itself form the mount 46 comprising one component of the present invention as shown in FIG. 6. Although shown as being mounted to a fluorescent fixture 10 in FIG. 6, a mount comprised of a single connector may be particularly useful when the ballast module of the present invention is utilized in connection with an LED lighting fixture, which generally requires minimal wiring (as compared to the multiple pairs of wires for a fluorescent fixture). An important feature of the invention, regardless of the form of the connectors 28A, 28B and/or inclusion of the stand-offs 48 and guides 50, is that the first connector halves 52 (FIGS. 3-5) or first connector half 52 (FIG. 6) are configured so that the ballast module 36 can only be mated to the second connector halves 52 (FIGS. 3-5) or second connector half 52 (FIG. 6) on fixture 10 in the proper orientation (relative to fixture 10) for achieving the required electrical connections. This proper, or one-way, orientation can be achieved either by configuring the connector 28 so that the two connector halves 52 can only be mated in the required orientation (FIG. 6) or by spacing of the connector halves 52B of connectors 28A, 28B on the shroud 12 of fixture 10 at a standard, or specified, distance (see line 54 on either of FIG. 1B or 2B) so that a ballast module having the halves 52A of connectors 28A, 28B spaced at that same standard distance 54 can be quickly and conveniently removed from or mounted to fixture 10, regardless of the manufacturer of the component parts of fixture 10.

As noted above, the modular ballast 36 of the present invention offers a number of advantages over the construction of prior light fixtures, and a primary advantage of the utilization of a mount 46, regardless of whether the mount 46 is comprised of stand-offs 48 and guides 50 as shown in FIG. 4 or is incorporated into the construction of the connectors 28 as shown in FIGS. 1-3 and 5-6, is the management of temperature in the fixture. Specifically, because the lamps 20 in fixture 10 operate more efficiently at higher temperature, the lamps 20 are positioned under shroud 12 and shroud 12 is preferably manufactured as a continuous piece of metal such as aluminum that contains and reflects the heat back from the surface of the underside of shroud 12. An additional advantage of aluminum construction of shroud 12 is the ability to polish the undersurface of the shroud to better reflect both light and heat and (because aluminum can be extruded, allowing for complex shapes) to form fins, ridges, or other structure on the top surface of shroud 12 to increase the surface area of that top surface to better radiate heat. This construction directs heat away from ballast module 36 and the ballasts 34A, 34B, 34C contained therein which are, as described above, sensitive to heat in that both their operating efficiency and their lifetime may be compromised by exposure to heat. In one embodiment, any structure formed on the top surface of shroud 12 to increase the surface area (and heat dissipation characteristics) of shroud 12 is formed on surfaces located at a distance away from ballast module 36 such as at the lateral margins of shroud 12 as indicated at the arrow 57 on FIGS. 1A and 2A. Further passive thermal management is accomplished by the air gap 56 (best shown in FIGS. 1 and 2, but also a feature of the mount 36 shown in FIG. 4) between the top surface of shroud 12 and the underside of ballast module 36 that serves to insulate the temperature sensitive electronics, such as the ballasts 34, from the heat produced by the lamps 20 in modular fixture 10. Although not shown in the figures, additional passive thermal management is accomplished by the addition of a layer of epoxy with thermal insulative properties, or other type of insulation, on the surface of ballast module 36 (or on the inside surface of ballast module 36) facing shroud 12 when mounted on mount 36.

In certain operating environments, the above-described passive thermal management capabilities of the modular fixture 10 of the present invention may not be sufficient to maximize the operating efficiency and service life of lamps 20 and ballasts 34. When fixture 10 is utilized in such operating environments, it is quickly and conveniently upgraded to incorporate active thermal management capability by adding a fan module 58 as shown in FIG. 4. Fan module 58 includes a small, low voltage exhaust fan 60, switched on and off at user-selectable temperature under control of a thermostat (not shown) or other suitable device as known in the art, for pulling ambient air through the openings 62 (see FIGS. 1A and 2A) through ballast module 36 to decrease the temperature to which the ballasts 34 in ballast module 36 are exposed. Although shown as being mounted to ballast module 36 by screws (not shown) threaded through screw holes 64 in FIG. 4, to illustrate the ease with which modular fixture 10 is upgraded to active thermal management, fan module 58 can be clipped (for instance, by spring-loaded clips that interact with complimentary-shaped detents or other structure formed on the inner or outer surface of ballast module 36) or its housing can be simply sized so that it fits by frictional engagement over the outside surface of ballast module 36.

The fan module 58 for active thermal management described in the preceding paragraph is but one example of the ease with which the modular fixture 10 of the present invention may be upgraded. Referring again to FIG. 4, it can be seen that a control module 64 can also be mounted to ballast module 36, preferably on the end of ballast module 36 opposite the end on which the fan module 58 is mounted (and in the embodiment shown, it can be seen that a friction fit such as is described above is utilized for mounting the control module 64 to ballast module 36). In one embodiment, control module 64 includes all the circuitry and electronics needed for “smart” control of the lamps 20 in fixture 10 as part of a network as described in the above-incorporated co-pending application Ser. No. 12/284,394, POINT OF USE AND NETWORK CONTROL OF ELECTRICAL APPLIANCES AND METHOD and in International Application No. PCT/US2010/002881, CONTROL MODULE FOR LIGHT FIXTURES AND METHOD. Those skilled in the art who have the benefit of this disclosure will recognize that the control module 64 described herein includes the same circuitry and electronics included in the controller 44 (see FIG. 3B), if utilized, and that there is no reason to mount both a controller 44 and a control module 64 on the same fixture 10.

In describing the upgrading of the modular fixture of the present invention by inclusion of control module 64, the advantage of the right-angle connectors 28A, 28B shown in FIG. 4 is made apparent. Specifically, the two halves 52A, 52B of each of connectors 28A, 28B include multi-pin connectors (indicated generally at reference numeral 66), enabling the use of a connector halve 52A on control module 64 (not visible in FIG. 4 because of the angle of the perspective view) to engage the proper pins of the multi-pin connector 66 of connector 28B to accomplish all the electrical connections needed to control the lamps 20 of fixture 10 in the manner described in co-pending application Ser. No. 12/284,394, POINT OF USE AND NETWORK CONTROL OF ELECTRICAL APPLIANCES AND METHOD and in International Application No. PCT/US2010/002881, CONTROL MODULE FOR LIGHT FIXTURES AND METHOD.

From the above description of fan 58 and control 64 modules, it can be seen that the modular fixture 10 of the present invention is easily upgraded for use in a particular installation and/or operating environment, or retrofit for a particular installation and/or operating environment, in true “plug and play” fashion and without changing the structure of the fixture 10. It is further apparent that when the fixture does need service, it need not be dis-assembled to, for instance, access the ballasts, nor does it require re-wiring. Instead, the ballast module 36 (and/or one or both of a fan 58 or control 64 modules, if utilized in the particular installation) is quickly and easily detached from the fixture and replaced with a new module 36 and without exposing the electrician to high voltage. Those skilled in the art who have the benefit of this disclosure will recognize that the light fixture of the present invention provides a level of adaptability and ease of assembly that allows the fixture to be utilized in many installations, the fixture being assembled on-site as needed for the particular installation and serviced on-site by detaching and replacing the controller without dis-assembling the fixture and/or disconnecting any wires quickly and with minimal exposure to electrical current. It will also be apparent that although the description set out herein is a description of a light fixture in which fluorescent lamps are mounted, the present invention also contemplates the mounting of other lamps in the fixture of the present invention. For instance, halogen lamps generate substantial heat such that the light fixture described herein is particularly well suited for use in a fixture utilizing halogen lamps because the lamps are separated and insulated from the electronic components by the compartmentalization of the electronics. The light fixture of the present invention is also adaptable for use with LED light sources and metal halide fixtures. All such changes, and others that will be clear to those skilled in the art from this description of the preferred embodiment(s) of the invention, are intended to fall within the scope of the following, non-limiting claims.

What is claimed is:

1. A light fixture comprising
a shroud having sockets mounted therein for supporting and making electrical connection to one or more lamps mounted in the sockets;
single or multiple connectors mounted to said shroud and electrically connected to the sockets mounted in said shroud, and to the electrical circuit of the building; and a ballast module detachably mounted to said shroud on said connectors, said ballast module comprising the electrical circuitry for energizing and operating the lamps, the electrical connections to said ballast module being made when said ballast module is mounted to said shroud.

2. The light fixture of claim 1 wherein said single connector or multiple connectors are placed at a specified location on said shroud in order to provide oriented and positive positioning for mated connectors on ballast module.

3. The light fixture of claim 1 wherein the oriented positioning and wiring of mated connectors allows for the use of the ballast module on shrouds produced by other manufacturers using the method of this invention.

4. The light fixture of claim 1 wherein the electrical circuit of the building is connected to the ballast module instead of shroud.

5. The light fixture of claim 1 wherein said shroud is provided with a mount for an external controller.

6. The light fixture of claim 1 additionally comprising an air gap between said ballast module and said shroud when said ballast module is mounted to said shroud.

7. The light fixture of claim 1 additionally comprising a thermostatically-controlled fan for cooling said ballast module.

8. The light fixture of claim 1 additionally comprising a fan mounted to said ballast module for cooling said ballast module.

9. The light fixture of claim 1 wherein said ballast module additionally comprises a control module operably connected to the electrical circuitry for energizing and operating the lamps, said control module comprising electrical circuitry for controlling the lamps and adapted for individual fixture control or for interacting with a wireless control network.

10. The light fixture system of claim 1 wherein the ballast module includes a microcontroller with a real time clock for recording operational state and temperature during the useful life of module.

11. The light fixture system of claim 1 wherein said ballast module can be connected to a testing and data management modular devise. Said devise being able to evaluate performance of ballast module and to harvest operational history data.

12. A method for optimizing life of electronics and lamps by using data harvested from the ballast module of claim 1 in order to change control switching sequence resulting in balanced aging of lamps and electronics thereby increasing system useful life.

13. A method of transferring operational history data to a new or replacement ballast module of claim 1 for the purpose of maintaining accurate lamp use history for future maintenance.

14. A method of determining the electric consumption of the fixture by using the operational state data recorded by the ballast module of claim 1 and comparing to the rated consumption of the fixture in each operational state.

15. A ballast module for a light fixture comprising a ballast, either a single connector or first and second connector halves, a microcontroller, and electrical wiring that terminates either at said connector or at one or both of said connectors for transmitting electrical signals from the microprocessor to the ballast and, when either said single connector or said connector halves are plugged into either a corresponding connector or corresponding connector halves on the light fixture, to the light fixture under the control of the microcontroller, either the single connector being configured so that the single connector can only be plugged into the connector on the light fixture in a specified orientation or the connector halves being spaced apart from each other at a specified distance for plugging into corresponding connector halves on the light fixture that are spaced apart at approximately the same specified distance.

16. The ballast module of claim 15 additionally comprising an air gap between the ballast module and the light fixture when the ballast module is mounted to the light fixture.

17. The ballast module of claim 16 wherein the size of the air gap is defined by the dimensions of said connectors.

18. The ballast module of claim 15 additionally comprising a positive lock for signaling the mating of either the connector or the connector halves, said positive lock being formed either on one or both of the connector halves, on the ballast module, or the light fixture.

19. A mount for the ballast module of a light fixture comprising first and second connector halves mounted in the respective light fixture and ballast module, the wiring of each of the light fixture and ballast module terminating at the first and second halves of said connector, said connector being configured so that the ballast module can be mounted to the light fixture in only a specified configuration and so that the ballast module is electrically connected to the light fixture when the respective first and second connector halves are engaged to each other to mount the ballast module to the light fixture, the with an air gap between the ballast module and the light fixture.

20. The mount of claim 19 wherein the size of the air gap is defined by the dimensions of said connectors.
